(19) United States
(12) Patent Application Publication
(10) Pub. No.: US 2008/0064342 A1
(43) Pub. Date: Mar. 13, 2008

(54) SWIVEL HINGE FOR USE IN HANDHELD DEVICE

(75) Inventors: Kyoung-Hoon Son, Gunpo-Si (KR); Seung-Hee Cho, Hwaseong-si (KR)

Correspondence Address: KNOBBE MARTENS OLSON & BEAR LLP, 2040 MAIN STREET, FOURTEENTH FLOOR, IRVINE, CA, 92614, US

(73) Assignee: AMPHENOL PHOENIX CO., LTD., HWASEONG-SI (KR)

(21) Appl. No.: 11/852,159

(22) Filed: Sep. 7, 2007

Related U.S. Application Data
(63) Continuation of application No. PCT/KR2006/000807, filed on Mar. 8, 2006.

(30) Foreign Application Priority Data
Mar. 8, 2005 (KR) 10-2005-0019221

(51) Int. Cl. H04B 1/38; F16M 13/00

(52) U.S. Cl. 455/90.3; 248/595

(57) ABSTRACT

Disclosed is a swing hinge for coupling first and second units with each other such that the first and second overlapped units can be rotated with respect to each other about an axis of rotation. The swing hinge includes a body shaped as a plate substantially perpendicular to the axis of rotation and coupled to the first unit; a rotating body coupled to the second unit and rotatable about the axis of rotation with respect to the body; a locking member movable in a radial direction; and a resilient member for urging the locking member inwardly in the radial direction.

### CROSS-REFERENCE TO RELATED PATENT APPLICATIONS

This application is a continuation application under 35 U.S.C. §365(c) of International Application No. PCT/KR2006/000807, filed Mar. 08, 2006 designating the United States. International Application No. PCT/KR2006/000807 was published in English as WO2006/096004 A1 on Sep. 14, 2006. This application further claims the benefit of the earlier filing date under 35 U.S.C. §365(b) of Korean Patent Application No. 10-2005-0019221 filed Mar. 08, 2005. This application incorporates herein by reference the International Application No. PCT/KR2006/000807 including the International Publication No. WO2006/096004 A1 and the Korean Patent Application No. 10-2005-0019221 in their entirety.

### BACKGROUND

1. Field

The present disclosure relates to a swivel hinge device, and more particularly swiveling two pieces of a handheld device.

2. Discussion of the Related Technology

A portable apparatus such as a portable telephone includes a keypad provided with a plurality of buttons and a liquid crystal display for providing a screen. In a case where a small liquid crystal display is used, the keypad and the liquid crystal display may be provided together in a single case unit. However, in a case where a larger liquid crystal display is used, it is not appropriate to allow the keypad and the liquid crystal display to be provided together in a single case unit. The reason is that it is inconvenient to carry the portable telephone due to its larger overall size. In order to conveniently carry the portable telephone as well as to utilize a larger liquid crystal display, a portable telephone including two case units which are foldable to each other and provided respectively with a keypad and a liquid crystal display has been recently and widely used. Further, as a variety of services such as video streaming and playback can be utilized through the portable telephone, a portable telephone in which a unit provided with the liquid crystal display can be rotated to allow the liquid crystal display to be disposed in a horizontal or vertical direction has also been widely used. To this end, a swing hinge for coupling the unit provided with the liquid crystal display to the other unit is required. The swing hinge should be thin and also have accurate operational characteristics.

### SUMMARY

One aspect of the invention provides a swivel hinge device for use in a handheld device, which comprises: a first member comprising a flange; and a second member comprising a body with a hole in a central portion thereof and further comprising guide walls formed in the body surrounding the hole, wherein the guide walls define a substantially annular guide channel with an opening toward the hole, wherein the guide channel receives the flange through the opening and is configured to guide the flange to rotate within the guide channel such that the first member is rotatably engaged with the second member.

In the foregoing device, the flange may be substantially annular. The first member may comprise a body from which the flange extends. The hole may receive a portion of the body. The first member may comprise a substantially annular body, and wherein the flange may be integrated with the substantially annular body. The flange may extend from an outer rim of the substantially annular body. The first member may be configured to be fixed with a first unit of the handheld device and the second member may be configured to be fixed with a second unit of the handheld device such that the first and second members are rotatable relative to each other. The guide walls may comprise two opposingly arranged walls with a gap therebetween, which forms the guide channel. The device may further comprise a locking mechanism providing a plurality of locking positions of the first member relative to the second member. The device may further comprise at least one stopper configured to limit a rotational movement of the first member relative to the second member.

Another aspect of the invention provides a handheld electronic device, which comprises: a first unit; a second unit; and the foregoing swivel hinge device, wherein the first member is substantially non-rotatably fixed to the first unit, wherein the second member is substantially non-rotatably fixed to the second unit, wherein the first unit is configured to swivel relative to the second unit.

In the foregoing handheld device, the device may further comprise a wire electrically interconnecting between the first and second units, wherein the first member may comprise a substantially annular body defining a hole through which the wire passes. The first unit may comprise a display surface facing away from the second unit such that the display surface is rotatable relative to the second unit about the rotational axis. The first member may comprise a body from which the flange extends. The body may comprise a portion located within the hole.

Still another aspect of the invention provides a method of using a handheld device, which comprises: providing a handheld device comprising a first unit, a second unit and the foregoing swivel hinge device, wherein the first member is substantially non-rotatably fixed to the first unit, wherein the second member is substantially non-rotatably fixed to the second unit, wherein the first unit is configured to swivel relative to the second unit; and rotating the first unit relative to the second unit about a rotational axis. In the foregoing method, the method may further comprise stopping further rotation of the first unit.

A further aspect of the invention provides a swivel hinge device for use in a handheld device, which comprises: a first member comprising a first body and a flange integrated with the first body; and a second member comprising a second body with a hole in a central portion thereof and further comprising a substantially annular guide channel formed in the body, wherein the hole receives at least part of the first body and the guide channel receives the flange, wherein the flange is rotatable about an axis within the guide channel such that the first and second members are rotatably engaged with each other. In the foregoing device, the flange may be substantially annular. The first body may be substantially annular, and wherein the flange may be integrated with the substantially annular body.

An aspect of the present invention is to provide a swing hinge adapted to a portable apparatus such as a portable telephone. Another aspect of the present invention is to provide a thinner swing hinge for use in a portable apparatus. A further aspect of the present invention is to provide an accurate swing hinge for use in a portable apparatus.

An aspect of the present invention provides a swing hinge for coupling first and second units with each other such that the first and second overlapped units can be rotated with respect to each other about an axis of rotation, which comprises a body shaped as a plate substantially perpendicular to the axis of rotation and coupled to the first unit; a rotating body coupled to the second unit and rotatable about the axis of rotation with respect to the body; a locking member movable in a radial direction; and a resilient member for urging the locking member inwardly in the radial direction. Further, the body includes a receiving space configured to receive the rotating body therein, first and second through-holes communicating with the receiving space and provided respectively at both ends in a longitudinal direction, and a guide passage communicating with the receiving space and receiving the locking member therein to guide the locking member; the rotating body includes an expansion portion received in the receiving space of the body and extending beyond a circumferential border of the through-hole in the radial direction, and a passage hole penetrated through the rotating body along the axis of rotation; and an outer circumferential surface of the expansion portion of the rotating body is brought into contact with the locking member.

The outer circumferential surface of the expansion portion of the rotating body may be provided with one or more locking grooves in which the locking member can be inserted. Preferably, an outer circumferential shape of the expansion portion of the rotating body is circular except the locking groove. The locking grooves may be arranged at an interval of 90 degrees. The body may include a first coupling body formed with the first through-hole and a second coupling body formed with the second through-hole. Preferably, a receiving recess defining the receiving space and a guide groove defining the guide passage are provided in one of the first and second coupling bodies.

Preferably, the rotating body is provided with at least one locking projection protruding outwardly in the radial direction and a pair of catching steps to which the locking projection of the rotating body is caught and which are opposite to each other along a circumferential direction are provided within the receiving recess. Preferably, the locking member is a spherical member, the resilient member is a compression coil spring, and the locking member and the resilient member are received in the guide groove. The rotating body may include at least one projection which is spaced apart from the axis of rotation and protrudes in a direction substantially parallel to the axis of rotation, and one of the first and second coupling bodies may be provided with an arc guide portion in which the projection is received and which extends in the circumferential direction. Preferably, resilient member is formed of a wire member and includes a contact portion convexly protruding to be brought into contact with the locking member. Preferably, the locking member is cylindrical. An aspect of the present invention provides a thinner, simple and accurate swing hinge, which can be appropriately used in the portable apparatus such as a portable telephone.

### BRIEF DESCRIPTION OF THE DRAWINGS

FIGS. 1(a) and (b) is plan and side views of a folder-type portable telephone in an unfolded state to which a swing hinge is mounted according to an embodiment of the present invention.

FIG. 2 is a perspective view of the swing hinge mounted to the portable telephone shown in FIG. 1.

FIG. 3 is a sectional view of the swing hinge shown in FIG. 2 taken along line A-A′.

FIGS. 4(a) and (b) is exploded perspective views of the swing hinge shown in FIG. 2.

FIGS. 5(a) to (c) is plan views illustrating respective operating steps of the swing hinge shown in FIG. 2.

FIG. 6 is a plan view of the portable telephone of FIG. 1 when the swing hinge is in a state shown in FIG. 5(c).

FIG. 7 is a perspective view of a swing hinge according to an embodiment of the present invention.

FIGS. 8(a) and (b) is exploded perspective views of the swing hinge shown in FIG. 7.

FIGS. 9(a) to (c) is plan views illustrating respective operating steps of the swing hinge shown in FIG. 7.

### DETAILED DESCRIPTION OF EMBODIMENTS

Hereinafter, embodiments of the present invention will be described in detail with reference to the accompanying drawings. This disclosure uses the terms “swing hinge” and “swivel hinge” interchangeably.

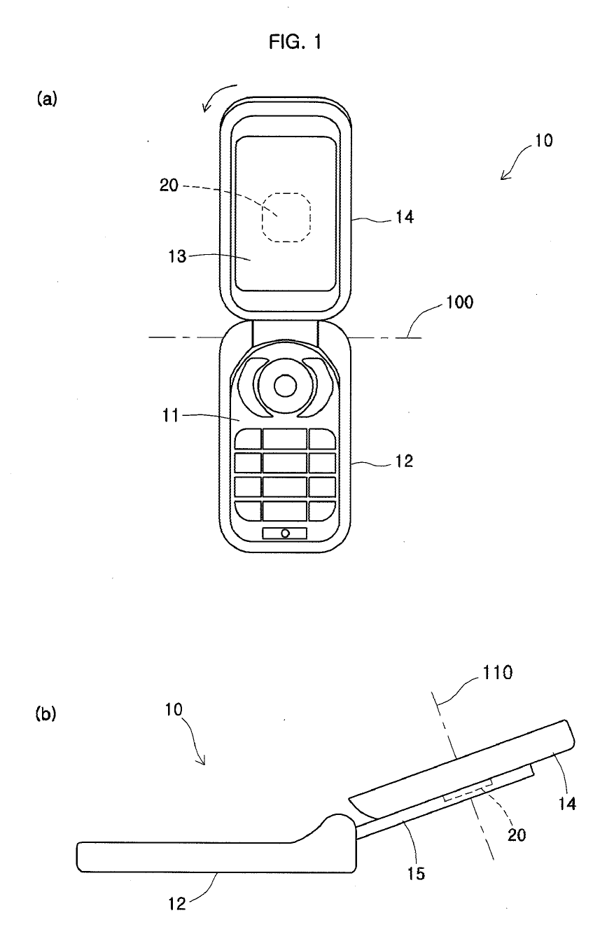

Referring to FIGS. 1(a) and (b), a portable telephone 10 mounted with a swing hinge 20 according to an embodiment of the present invention includes a first case member 12 provided with a keypad 11 and a second case member 14 provided with a liquid crystal display 13. The first case member 12 is provided with a coupling plate 15 which is connected to be rotatable about a first axis of rotation 100 such that the first and second case members can be folded or unfolded with respect to each other. The second case member 14 is coupled to the coupling plate 15 such that the two case members 12 and 14 can be rotated about the first axis of rotation 100 to be folded or unfolded with respect to each other. The second case member 14 and the coupling plate 15 are coupled such that they overlap each other by means of the swing hinge 20. The second case member 14 can be rotated about a second axis of rotation 110 by means of the swing hinge 20 with respect to the coupling plate 15. The second axis of rotation 110 extends to be substantially perpendicular to both the coupling plate 15 and the second case member 14. It is preferred that the second axis of rotation 110 pass through a central portion of the second case member 14. Although it is not shown in detail, the coupling plate 15 is provided with a seating recess in which the swing hinge 20 is fitted. It is preferred that an external appearance of the seating recess is substantially identical to that of the swing hinge 20.

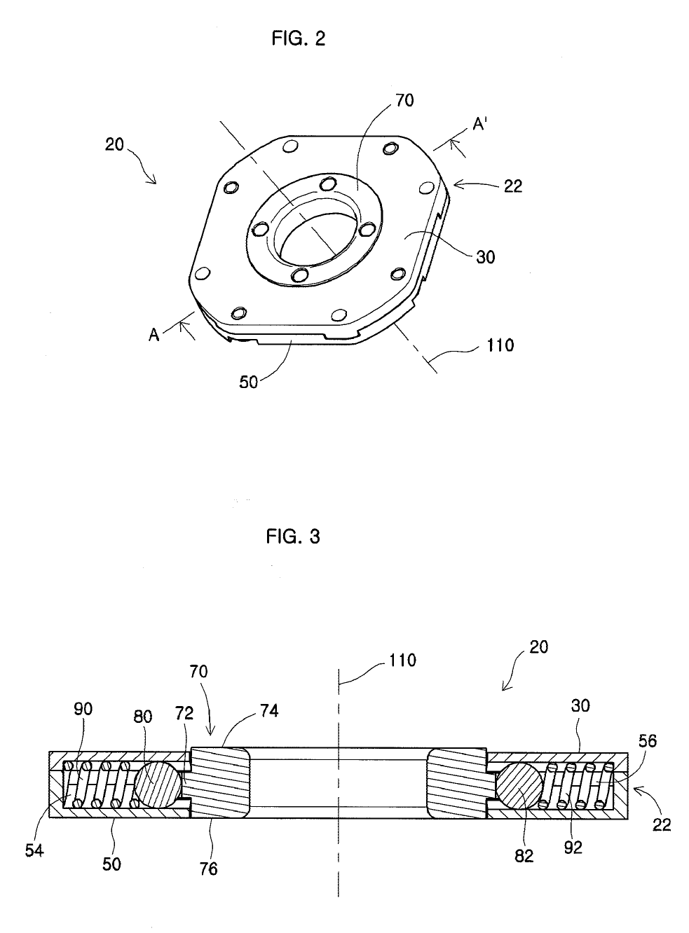

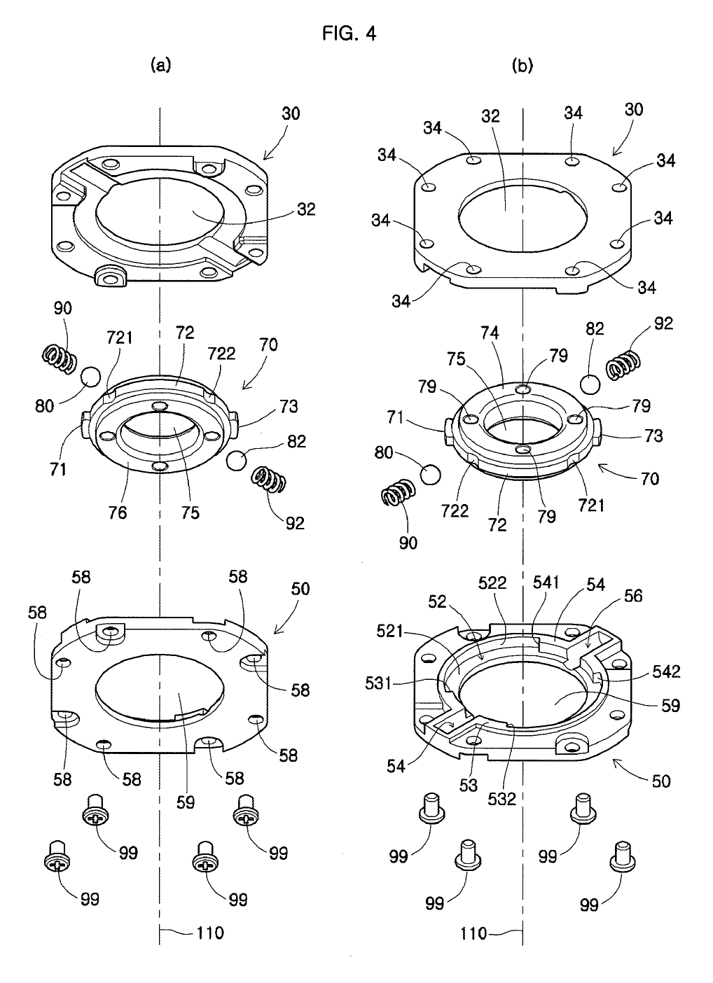

Referring to FIGS. 2 to 4, the swing hinge 20 is shaped as a substantially thin plate perpendicular to the second axis of rotation 110 and includes a first coupling body 30, a second coupling body 50, a rotating body 70, first and second locking members 80 and 82, and first and second resilient members 90 and 92. The first and second coupling bodies 30 and 50 are coupled to face each other to thereby form an assembled body 22. The first coupling body 30 is shaped as a square plate with rounded corners and is configured to be perpendicular to the second axis of rotation 110. A central portion of the first coupling body 30 is provided with a circular through-hole 32 which is centered with respect to the second axis of rotation 110. A first end 74 of the rotating body 70 to be described later is exposed through the through-hole 32. The through-hole 32 is slightly larger than the first end 74 of the rotating body 70 but is smaller than a central expansion portion 72 of the rotating body 70 to be described later. Accordingly, the rotating body 70 is not escaped from the through-hole 32 of the first coupling body 30. A plurality of coupling bolt holes 34 are formed in an edge portion of the first coupling body 30 to penetrate through the first coupling body. Some of the bolt holes 34 are intended for coupling bolts 99 for coupling the first coupling body 30 and the second coupling body 50 with each other, and the other bolt holes 34 are intended for bolts (not shown) for coupling the coupling plate 15 (FIG. 1(b)) and the assembled body 22 with each other.

The second coupling body 50 is shaped as a square plate with rounded corners, which is substantially the same as the first coupling body 30, and is perpendicular to the second axis of rotation 110. A central portion of one surface (a surface facing the first coupling body 30) of the second coupling body 50 is provided with a circular receiving recess 52 centered with respect to the second axis of rotation 110 and first and second guide grooves 54 and 56 communicating with the receiving recess 52. The rotating body 70 is received in the receiving recess 52. A through-hole 59 is formed through a base 521 of the receiving recess 52. A second end 76 of the rotating body 70 to be described later is exposed through the through-hole 59. The through-hole 59 is slightly larger than the second end 76 of the rotating body 70 but is smaller than the central expansion portion 72 of the rotating body 70 to be described later. Accordingly, the rotating body 70 is not escaped from the through-hole 59 of the second coupling body 50. First and second protrusions 53 and 54 which are positioned opposite to each other and protrude inwardly in a radial direction are formed on a sidewall 522 that defines a circumferential border of the receiving recess 52. At both circumferential ends of the first protrusion 53 are respectively formed a first A catching step 531 and a first B catching step 532. At both circumferential ends of the second protrusion 54 are respectively formed a second A catching step 541 and a second B catching step 542. The first A catching step 531 and the second A catching step 541 face each other along the circumferential direction, whereas the first B catching step 532 and the second B catching step 542 face each other along the circumferential direction. In the space between the first A catching step 531 and the second A catching step 541 is positioned a first locking projection 71 of the rotating body 70 to be described later. In the space between the first B catching step 532 and the second B catching step 542 is positioned a second locking projection 73 to be described later. The interaction between the first and second locking projections 71 and 73 of the rotating body 70 and the first A, second A, first B and second B catching steps 531, 541, 532 and 542 formed on the second coupling body 50 limits the rotational range of the rotating body 70. The first A, second A, first B and second B catching steps 531, 541, 532 and 542 are arranged such that the rotational range of the rotating body 70 can be 90 degrees. However, the present invention is not limited thereto.

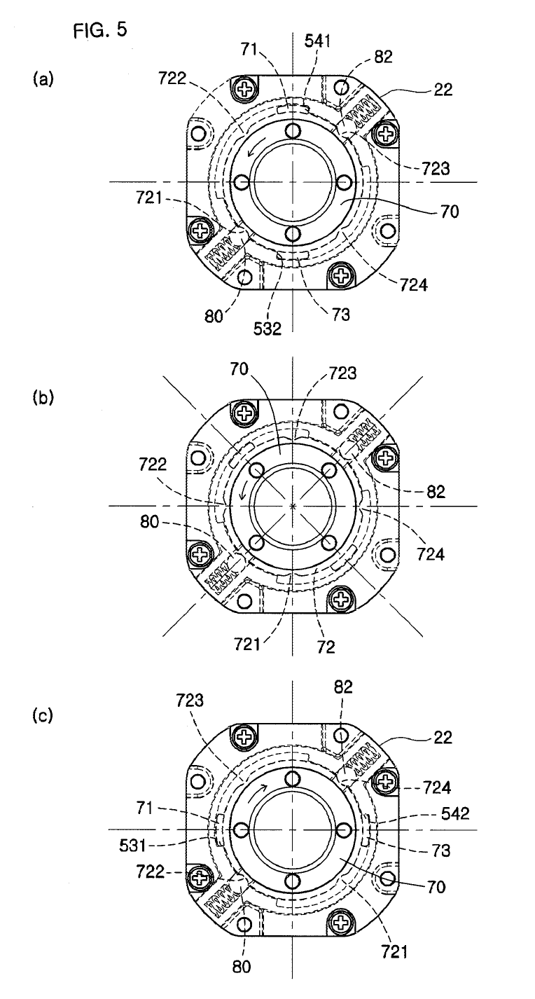

The first guide groove 54 and the second guide groove 56 are positioned to face each other beyond the circumferential border of the receiving recess 52. The first guide groove 54 is positioned in the middle of the first protrusion 53 and the second guide groove 56 is positioned in the middle of the second protrusion 54. The two guide grooves 54 and 56 extend outwardly in a radial direction. In the first guide groove 54 are received the first resilient member 90 and the first locking member 80. The first resilient member 90 is a compression coil spring and is positioned outwardly in a radial direction. Further, the first locking member 80 takes the shape of a sphere and is positioned inwardly in a radial direction. The first resilient member 90 applies a force to the first locking member 80 such that the first locking member 80 can be moved inwardly in a radial direction. If the first locking member 80 is brought into contact with an outer circumferential surface of the central expansion portion 72 of the rotating body 70 and can be inserted in a first A locking groove 721 and a second A locking groove 722. In the second guide groove 56 are received the second resilient member 92 and the second locking member 82. The second resilient member 92 is a compression coil spring and is positioned outwardly in a radial direction. Further, the second locking member 82 takes the shape of a sphere and is positioned inwardly in a radial direction. The second resilient member 92 applies a force to the second locking member 82 such that the second locking member 82 can be moved inwardly in a radial direction. The second locking member 82 is brought into contact with the outer circumferential surface of the central expansion portion 72 of the rotating body 70 and can be inserted in a first B locking groove 723 (FIG. 5(a)) and a second B locking groove 724 (FIG. 5(a)). A plurality of coupling bolt holes 58 are formed in an edge portion of the second coupling body 50 to penetrate through the second coupling body at positions corresponding to the bolt holes 34 formed in the first coupling body 30. Some of the bolt holes 58 are intended for the coupling bolts 99 for coupling the first coupling body 30 and the second coupling body 50 with each other, and the other bolt holes 58 are intended for the bolts (not shown) for coupling the coupling plate 15 (FIG. 1(b)) and the assembled body 22 with each other.

Referring to FIGS. 2 to 4, the rotating body 70 takes the shape of a ring and is provided with a circular passage hole 75 centered with respect to the second axis of rotation 110 at a central portion thereof. A wiring for electrically connecting the two case members 12 and 14 of the portable telephone 10 (FIG. 1) to each other can pass through the passage hole 75. The rotating body 70 includes the first end 74, the central expansion portion 72 and the second end 76 which are positioned sequentially along the direction of extension of the second axis of rotation 110. The first and second ends 74 and 76 have the substantially same radius and are exposed outside to protrude through the through-hole 32 of the first coupling body 30 and the through-hole 59 of the second coupling body 50, respectively. The central expansion portion 72 is further expanded outwardly in a radial direction from the first and second ends 74 and 76 and is received in the receiving recess 52 of the second coupling body 50. The first and second locking projections 71 and 73 further protruding outwardly in a radial direction are provided at predetermined positions on the outer periphery of the central expansion portion 72. The first locking projection 71 is positioned between the first A catching step 531 and the second A catching step 541 of the second coupling body 50, whereas the second locking projection 73 is positioned between the first B catching step 532 and the second B catching step 542 of the second coupling body 50. The interaction between the first and second locking projections 71 and 73 of the rotating body 70 and the first A, second A, first B and second B catching steps 531, 541, 532 and 542 formed on the second coupling body 50 limits the rotational range of the rotating body 70 to 90 degrees. The first and the second locking members 80 and 82 are brought into contact with an outer circumferential surface of the central expansion portion 72. At this time, the rotating body 70 is kept at a stop state by means of frictional force. On the outer circumferential surface of the central expansion portion 72 is provided the first A, second A, first B and second B arc-shaped locking grooves 721, 722, 723 and 724 (FIG. 5(a)) disposed at an interval of 90 degrees along the circumferential direction. The first locking member 80 may be inserted in the first A and second A locking grooves 721 and 722, whereas the second locking member 82 may be inserted in the first B and second B locking grooves 723 and 724 (FIG. 5 (a)). At this time, the rotating body 70 is not stationary. If a sufficient rotational force is applied to the rotating body at this state, the first and second locking members 80 and 82 can be escaped from the first A, second A, first B and second B locking grooves 721, 722, 723 and 724 (FIG. 5(a)). The rotating body 70 is provided with a plurality of coupling holes 79 which are arranged along the circumferential direction. The rotating body 70 is coupled to the second case member 14 of the portable telephone 10 (FIG. 1) with means such as coupling bolts (not shown) through these coupling holes 79.

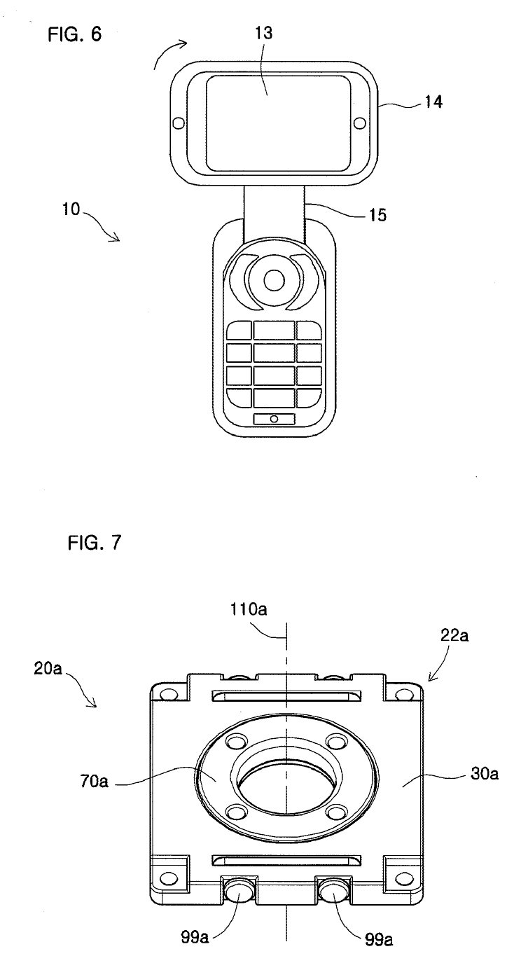

Referring now to FIGS. 1, 5 and 6, the operation of the hinge according to one embodiment of the present invention will be described in detail. Although it has not been illustrated herein in detail, the assembled body 22 (FIG. 2) of the swing hinge 20 is connected to the coupling plate 15, and the rotating body 70 (FIG. 2) of the swing hinge 20 is connected to the second case member 14. Referring to FIG. 1(a), the portable telephone 10 is unfolded and the liquid crystal display 13 of the second case member 14 is vertically oriented. The state of the swing hinge 20 for connecting the second case member 14 and the coupling plate 15 to each other at this time has been shown in FIG. 5(a). Referring to FIG. 5(a), the first locking member 80 is inserted in the first A locking groove 721 of the rotating body 70 and the second locking member 82 is inserted in the first B locking groove 723 of the rotating body 70. At this time, the first locking projection 71 of the rotating body 70 is brought into contact with the second A catching step 541 and the second locking projection 73 of the rotating body 70 is brought into contact with the first B catching step 532. Accordingly, the rotating body 70 cannot be rotated clockwise (in a direction opposite to the arrow direction) with respect to the assembled body 22. In such a state, if a sufficient rotational force is applied counterclockwise (in the arrow direction) to the second case member 14 of the portable telephone 10 about the second axis of rotation 110 with respect to the coupling plate 15, the first and second locking members 80 and 82 can be escaped from the first A and first B locking grooves 721 and 723 of the rotating body 70, respectively, and thus, the rotating body 70 can be rotated counterclockwise using a smaller rotational force. FIG. 5(b) shows a state where the rotating body 70 has been rotated by 45 degrees. Referring to FIG. 5(b), the first and second locking members 80 and 82 are brought into contact with the outer circumferential surface of the central expansion portion 72 of the rotating body 70. FIG. 5(c) shows a state where the rotational force is further applied and thus the rotating body 70 has been rotated counterclockwise (in the arrow direction) by 45 degrees. Referring to FIG. 5(c), the first locking member 80 is inserted in the second A locking groove 722 of the rotating body 70 and the second locking member 82 is inserted in the second B locking groove 724 of the rotating body 70. At this time, the first locking projection 71 of the rotating body 70 is brought into contact with the first A catching step 531, and the second locking projection 73 of the rotating body 70 is brought into contact with the second B catching step 542. Therefore, the rotating body 70 cannot be rotated counterclockwise (in a direction opposite to the arrow direction) with respect to the assembled body 22. The state of the portable telephone 10 at this time is shown in FIG. 6. Referring to FIG. 6, the second case member 14 of the portable telephone 10 is disposed such that the liquid crystal display 13 is horizontally oriented. In this state, if a sufficient rotational force is applied clockwise (in the arrow direction) to the second case member 14 of the portable telephone 10 about the second axis of rotation 110 with respect to the coupling plate 15, the first and second locking members 80 and 82 can be escaped from the second A and second B locking grooves 722 and 724, respectively, and thus the rotating body 70 can be rotated clockwise using a smaller rotational force. Through the above processes, the portable telephone 10 can be returned again to a state shown in FIG. 1(a).

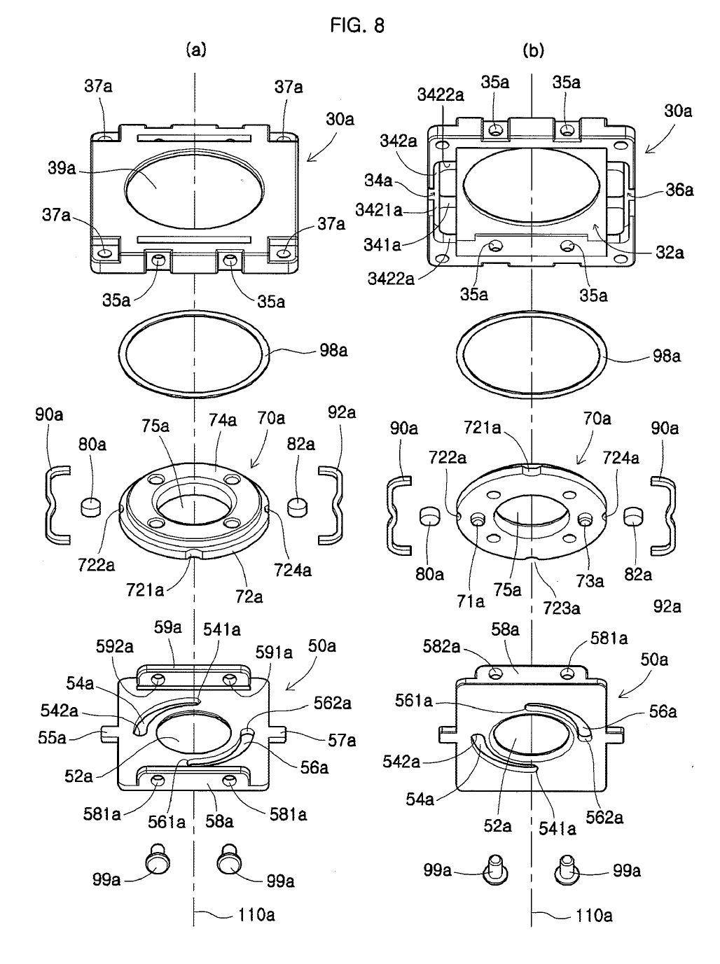

FIGS. 7 to 9 show a swing hinge according to an embodiment of the present invention. The swing hinge shown in FIG. 7 is mounted to the portable telephone in the same manner as the swing hinge shown in FIG. 2. Referring to FIGS. 7 and 8, a swing hinge 20a is shaped as a substantially thin plate perpendicular to an axis of rotation 110a and includes a first coupling body 30a, a second coupling body 50a, a rotating body 70a, first and second locking members 80a and 82a, and first and second resilient members 90a and 92a. The first and second coupling bodies 30a and 50a are coupled to face each other to thereby form an assembled body 22a. The first coupling body 30a is shaped as a square plate and is configured to be perpendicular to the axis of rotation 110a. In one surface (a surface facing the second coupling body 50a) of the first coupling body 30a is provided a rectangular receiving recess 32a positioned at a central portion thereof and first and second seating grooves 34a and 36a positioned at both sides of the receiving recess 32a. Both the rotating body 70a and a washer 98a to be described later are received in the receiving recess 32a. A through-hole 39a is formed through a base 321a of the receiving recess 32a. An exposed end 74a of the rotating body 70a to be described later is exposed through the through-hole 39a. The through-hole 39a is slightly larger than the exposed end 74a of the rotating body 70a but is smaller than an expansion portion 72a of the rotating body 70a to be described later. Therefore, the rotating body 70a cannot be escaped through the through-hole 39a of the first coupling body 30a.

The first seating groove 34a includes a locking member receiving portion 341a and a resilient member receiving portion 342a. The locking member receiving portion 341a communicates with the receiving recess 32a and slightly extends from the receiving recess 32a outwardly in a radial direction. The first locking member 80a is received in the locking member receiving portion 341a. The first locking member 80a is shaped as a flat cylinder and received in the locking member receiving portion in such a manner that the centerline thereof is parallel with the axis of rotation 110a. The first locking member 80a can be moved within the locking member receiving portion 341a in a radial direction. The first resilient member 90a applies a certain force to the first locking member 80a such that the first locking member 80a can be moved inwardly in a radial direction. An outer circumferential surface of the first locking member 80a is brought into contact with the outer circumferential surface of the expansion portion 72a of the rotating body 70a and can be inserted in a first A locking groove 721a or second A locking groove 722a which is formed on an outer periphery of the expansion portion 72a of the rotating body 70a. The locking member receiving portion 341a serves to guide the movement of the first locking member 80a. The resilient member receiving portion 342a includes a central portion 3421a connected to the locking member receiving portion 341a and extending to be substantially perpendicular to the locking member receiving portion 341a and a bent extension portion 3422a bent from both ends of the central portion 3421a and extending toward the receiving recess 32a. The first resilient member 90a is received in the resilient member receiving portion 342a. The first resilient member 90a is formed of a resilient wire member, and its central portion is formed into a contact portion 91a that is curved to convexly protrude toward a side and brought into contact with the first locking member 80a. Both ends of the first resilient member 90a are bent to extend slightly toward the one side such that they can be received in the locking member receiving portion 341a. The first resilient member 90a allows the first locking member 80a to be pushed inwardly in a radial direction. Since the second seating groove 36a is symmetrical to the first seating groove 34a in view of their configuration, a detailed description thereof will be omitted herein. The second locking member 82a and the second resilient member 92a are received in the second seating groove 36a and are the same as the first locking member 80a and the first resilient member 90a, respectively. Therefore, a detailed description thereof will be omitted herein. A plurality of bolt holes 35a bored through the side surfaces of the other opposite sides of the first coupling body 30a into the receiving recess 32a are provided on the other opposite sides where neither the first seating grooves 34a nor the second seating groove 36a are positioned. A coupling bolt 99a is inserted through each of the bolt holes 35a to couple the first and second coupling bodies 30a and 50a with each other. Coupling holes 37a are provided to penetrate four corner portions of the first coupling body 30a. The coupling holes 37a are intended for bolts (not shown) for coupling the coupling plate 15 (FIG. 1(b)) and the body 22a with each other.

The second coupling body 50a is shaped as a square plate and is perpendicular to the second axis of rotation 110a. It is preferred that the second coupling body 50a be sized to be exactly fitted into the receiving recess 32a of the first coupling body 30a. A circular through-hole 52a centered with respect to the axis of rotation 110a is formed through a central portion of the second coupling body 50a. The through-hole 52a is connected with a passage hole 75a of the rotating body 70a. The second coupling body 50a is provided with first and second extension grooves 54a and 56a which are symmetric with each other with respect to the axis of rotation 110a. Each of the first and second extension grooves 54a and 56a is formed into an arc centered with respect to the axis of rotation 110a. A first projection 71a of the rotating body 70a to be described later is received in the first extension groove 54a, whereas a second projection 73a of the rotating body 70a is received in the second extension groove 56a. Both circumferential ends of the first extension groove 54a become first A and second A catching ends 541a and 542a, respectively. Both circumferential ends of the second extension groove 56a become first B and second B catching ends 561a and 562a, respectively. The first and second projections 71a and 73a of the rotating body 70a are caught to the first A and second A catching ends 541a and 542a, and the first B and second B catching ends 561a and 562a, respectively, to restrict the rotation of the rotating body 70a. The first and second extension grooves 54a and 56a are configured such that the rotational range of the rotating body 70a can be limited to 90 degrees. However, the present invention is not limited thereto.

First and second protrusions 55a and 57a are provided on two opposite sides of the second coupling body 50a, respectively, whereas first and second sidewalls 58a and 59a are provided on the other two opposite sides thereof, respectively. The first and second protrusions 55a and 57a are positioned in the locking member receiving portion 341a of the first seating groove 34a and a locking member receiving portion 361a of the second seating groove 36a, respectively, to prevent the two locking members 80a and 82a from being escaped. The first and second sidewalls 58a and 59a enter the receiving recess 32a of the first coupling body 30a. Bolt holes 581a and 582a, 591a and 592a are formed through the first and second sidewalls 58a and 59a, respectively. The bolts 99a are inserted into the bolt holes 581a, 582a, 591a and 592a and the bolt holes 35a of the first coupling body 30a, respectively, such that the first and second coupling bodies 30a and 50a can be coupled with each other.

The rotating body 70a takes the shape of a ring having the passage hole 75a at the center thereof. The rotating body 70a includes the exposed end 74a and the expansion portion 72a. The exposed end 74a is exposed to the outside through the through-hole 39a of the first coupling body 30a. The expansion portion 72a has a radius greater than that of the exposed end 74a and is further expanded outwardly in a radial direction. An outer circumferential surface of the expanded portion 72a is provided with the first A, second A, first B and second B arc locking grooves 721a, 722a, 723a and 724a disposed at an interval of 90 degrees along the circumferential direction. The first locking member 80a may be inserted in the first A and second A locking grooves 721a and 722a, and the second locking member 82a may be inserted in the first B and second B locking grooves 723a and 724a. At this time, the rotating body 70a is not stationary. The first and the second projections 71a and 73a positioned symmetric to each other are provided on a bottom surface (i.e., the side opposite to the exposed end 74a) of the rotating body 70a. The first and second projections 71a and 73a are received in the first and second extension grooves 54a and 56a of the second coupling body 50a, respectively, and interact with the respective catching ends 541a, 542a, 561a and 562a to limit the rotational range of the rotating body 70a to 90 degrees. The washer 98a is inserted in the vicinity of the exposed end 74a.

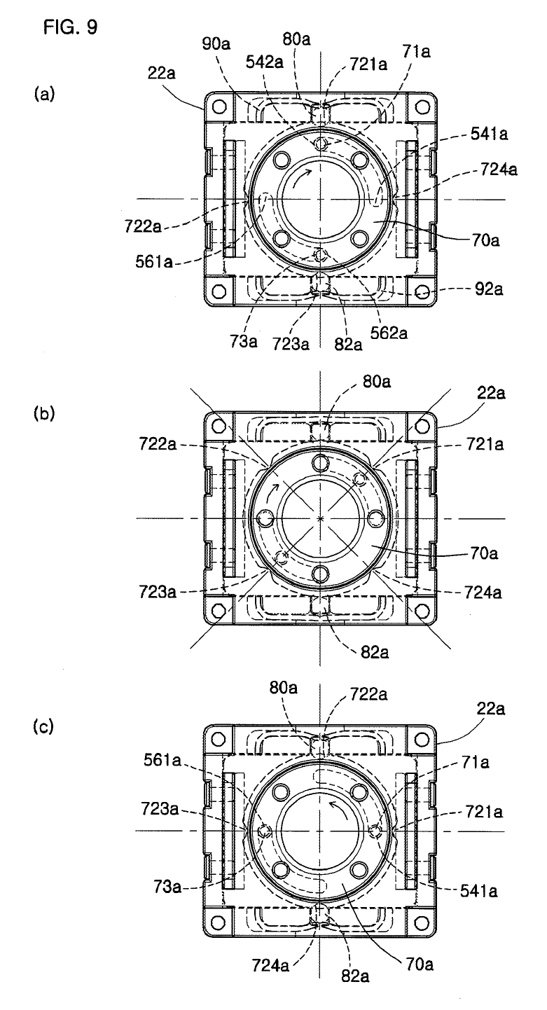

Now, the operation of the hinge according to one embodiment of the present invention will be described in detail with reference to FIG. 9. Referring to FIG. 9 (a), the first locking member 80a is inserted in the first A locking groove 721a of the rotating body 70a, while the second locking member 82a is inserted in the first B locking groove 723a of the rotating body 70a. At this time, the first projection 71a of the rotating body 70a is brought into contact with the second A catching step 542a, while the second projection 73a of the rotating body 70a is brought into contact with the second B catching step 562a. Therefore, the rotating body 70a cannot be rotated counterclockwise (in a direction opposite to the arrow direction) with respect to the assembled body 22a. In such a state, if a sufficient rotational force is applied clockwise (in the arrow direction), the first and second locking members 80a and 82a are unlocked from the first A locking groove 721a and the first B locking groove 723a of the rotating body 70a, respectively, and the rotating body 70a can be then rotated clockwise with a smaller rotational force. FIG. 9(b) shows a state where the rotating body 70a is rotated further by 45 degrees. Referring to FIG. 9(b), the first and second locking members 80a and 82a are brought into contact with the outer circumferential surface of the expansion portion 72a of the rotating body 70a. FIG. 9(c) shows a state where the rotational force is further applied at this state and thus the rotating body 70a has been further rotated clockwise (in the arrow direction) by 45 degrees. Referring to FIG. 9(c), the first locking member 80a is inserted in the second A locking groove 722a of the rotating body 70a, while the second locking member 82a is inserted in the second B locking groove 724a of the rotating body 70a. At this time, the first projection 71a of the rotating body 70a is brought into contact with the first A catching end 541a, while the second projection 73a of the rotating body 70a is brought into contact with the first B catching end 561a. Therefore, the rotating body 70a cannot be rotated clockwise (in the direction opposite to the arrow direction) with respect to the assembled body 22a. In such a state, if a sufficient rotational force is applied counterclockwise (in the arrow direction), the first locking member 80a and the second locking member 82a are unlocked from the second A locking groove 722a and the second B locking groove 724a of the rotating body 70a, and thus the rotating body 70a can be then rotated clockwise with a smaller rotational force.

Although it has been described in the above embodiments that the swing hinge is used in the portable telephone, the present invention is not limited thereto. It will be easily understood by those skilled in the art that the swing hinge can also be used in the other portable apparatus.

Although embodiments of the present invention has been illustrated and described, the invention is not limited thereto. It will be understood by those skilled in the art that various modifications and changes can be made thereto without departing from the scope and spirit of the present invention and such various modifications and changes will also be included in the scope of the present invention.

What is claimed is:

1. A swivel hinge device for use in a handheld device, the hinge comprising:
a first member comprising a flange; and
a second member comprising a body with a hole in a central portion thereof and further comprising guide walls formed in the body surrounding the hole, wherein the guide walls define a substantially annular guide channel with an opening toward the hole, wherein the guide channel receives the flange through the opening and is configured to guide the flange to rotate within the guide channel such that the first member is rotatably engaged with the second member.

2. The device of claim 1, wherein the flange is substantially annular.

3. The device of claim 1, wherein the first member comprises a body from which the flange extends.

4. The device of claim 3, wherein the hole receives a portion of the body.

5. The device of claim 1, wherein the first member comprises a substantially annular body, and wherein the flange is integrated with the substantially annular body.

6. The device of claim 5, wherein the flange extends from an outer rim of the substantially annular body.

7. The device of claim 1, wherein the first member is configured to be fixed with a first unit of the handheld device and the second member is configured to be fixed with a second unit of the handheld device such that the first and second members are rotatable relative to each other.

8. The device of claim 1, wherein the guide walls comprises two opposingly arranged walls with a gap therebetween, which forms the guide channel.

9. The device of claim 1, further comprising a locking mechanism providing a plurality of locking positions of the first member relative to the second member.

10. The device of claim 1, further comprising at least one stopper configured to limit a rotational movement of the first member relative to the second member.

11. A handheld electronic device, comprising:
a first unit;
a second unit; and
the swivel hinge device of claim 1, wherein the first member is substantially non-rotatably fixed to the first unit, wherein the second member is substantially non-rotatably fixed to the second unit, wherein the first unit is configured to swivel relative to the second unit.

12. The device of claim 11, further comprising a wire electrically interconnecting between the first and second units, wherein the first member comprises a substantially annular body defining a hole through which the wire passes.

13. The device of claim 11, wherein the first unit comprises a display surface facing away from the second unit such that the display surface is rotatable relative to the second unit about the rotational axis.

14. The device of claim 11, wherein the first member comprises a body from which the flange extends.

15. The device of claim 14, wherein the body comprises a portion located within the hole.

16. A method of using a handheld device, the method comprising:
providing a handheld device comprising a first unit, a second unit and the swivel hinge device of claim 1, wherein the first member is substantially non-rotatably fixed to the first unit, wherein the second member is substantially non-rotatably fixed to the second unit, wherein the first unit is configured to swivel relative to the second unit; and
rotating the first unit relative to the second unit about a rotational axis.

17. The method of claim 16, further comprising stopping further rotation of the first unit.

18. A swivel hinge device for use in a handheld device, the hinge comprising:
a first member comprising a first body and a flange integrated with the first body; and
a second member comprising a second body with a hole in a central portion thereof and further comprising a substantially annular guide channel formed in the body, wherein the hole receives at least part of the first body and the guide channel receives the flange, wherein the flange is rotatable about an axis within the guide channel such that the first and second members are rotatably engaged with each other.

19. The device of claim 18, wherein the flange is substantially annular.

20. The device of claim 18, wherein the first body is substantially annular, and wherein the flange is integrated with the substantially annular body.
